(19) United States
(12) Patent Application Publication
(10) Pub. No.: US 2021/0060998 A1
(43) Pub. Date: Mar. 4, 2021

(54) ELECTRONIC BLACKBOARD

(71) Applicant: SHENZHEN HITEVISION TECHNOLOGY CO., LTD., Shenzhen (CN)

(72) Inventor: Qiyun ZUO, Shenzhen (CN)

(21) Appl. No.: 16/961,566

(22) PCT Filed: Sep. 26, 2019
(86) PCT No.: PCT/CN2019/108252

§ 371 Date: Jul. 10, 2020

(30) Foreign Application Priority Data
Sep. 27, 2018 (CN) 201821588821.1

(51) Int. Cl. B43L 1/10; G02F 1/1335; G02F 1/1333

(52) U.S. Cl. CPC B43L 1/10; G02F 1/13338; G02F 1/133502

(57) ABSTRACT

The present disclosure relates to an electronic blackboard, including a liquid crystal display panel and at least one metal panel, wherein the liquid crystal display panel includes a liquid crystal screen, and a surface of the liquid crystal screen is provided with a glass board; the metal panel comprises a first metal sheet, a supporting board and a second metal sheet, with same being sequentially arranged; and a surface of the first metal sheet is coated with a coating for writing on with a piece of chalk or a stylus pen.

The present application is proposed based on the Chinese Application No. 201821588821.1 filed on Sep. 27, 2018, and claims priority of this Chinese Application, which is entirely incorporated herein by reference.

### TECHNICAL FIELD

The present application relates to the field of electronic blackboards, and in particular relates to an electronic blackboard.

### BACKGROUND

Existing electronic blackboard generally includes a display screen portion and a blackboard portion without display screen, wherein a surface of the display screen portion is usually made of glass, and a surface of the blackboard portion without display screen is usually also made of glass. However, characters written with chalk or whiteboard pens on the glass plate are not clear, and the glass plate has a tendency towards light reflection, and also is heavy, fragile and costly.

### SUMMARY

Directing to the above defects of the existing electronic blackboard, the present application provides an electronic blackboard, which may overcome the defects of tendency towards light reflection, large weight, being fragile and costly, for side plates of the electronic blackboard.

The technical solution of the present application for solving its technical problem is to provide an electronic blackboard, including a liquid crystal display panel and at least one metal panel; the liquid crystal display panel includes a liquid crystal screen, and a glass plate is provided on a surface of the liquid crystal screen; the metal panel includes a first metal sheet, a support plate, and a second metal sheet arranged in sequence, and a surface of the first metal sheet is coated with a coating layer for writing with chalk or whiteboard pens.

Wherein, said liquid crystal display panel and the metal panel are joined together in a planar manner.

Wherein, said glass plate is made of anti-glare toughened glass. Wherein, a surface of said anti-glare toughened glass is coated with a coating layer for writing with chalk or whiteboard pens.

Wherein, a touch film is attached on a side of said glass plate facing the liquid crystal screen.

Wherein, said glass plate is attached to one side of the touch film in a full lamination manner, and the other side of said touch film is attached to the liquid crystal screen in a full lamination manner.

Wherein, said first metal sheet and the second metal sheet are thin steel plates.

Wherein, a thickness of said thin steel plate is no less than 0.2 mm and no more than 1 mm.

Wherein, said support plate is a honeycomb plate.

Wherein, said honeycomb plate is an aluminum honeycomb plate.

Wherein, a height of said aluminum honeycomb plate is no less than 10 mm and no more than 20 mm.

Wherein, the height of said aluminum honeycomb plate is 15 mm.

Wherein, a material thickness of said aluminum honeycomb plate is 0.03 mm to 0.1 mm.

Wherein, the material thickness of said aluminum honeycomb plate is 0.05 mm.

Wherein, the coating layer on the surface of said first metal sheet is a nano-coating layer.

Wherein, said nano-coating layer has a Rockwell hardness not less than 3H.

In the embodiments of the present application, a metal panel is used for the writing area of the electronic blackboard, and the metal panel employs a design of two metal sheets with a support plate provided therebetween, to replace the glass plate in the writing area of the existing electronic blackboard. Thus, the defects of being unclear when writing with chalk or whiteboard pens and tendency towards light reflection may be avoided, and the metal panel has characteristics of high strength, light weight, being not fragile, and low cost.

### BRIEF DESCRIPTION OF THE DRAWINGS

In order to more clearly explain embodiments of the present application or the technical solutions in the prior art, the accompanying drawings used for describing the embodiments or the prior art will be briefly described below. Obviously, the accompanying drawings in the following description are only some embodiments of the present application, and the person skilled in the art can obtain other accompanying drawings based on these accompanying drawings without expending any creative labor.

FIG. 1 is a schematic structural diagram of a two-segment electronic blackboard according to an embodiment of the present application;

FIG. 2 is a schematic structural diagram of the metal panel as shown in FIG. 1;

FIG. 3 is a schematic structural diagram of a two-segment electronic blackboard according to another embodiment of the present application;

FIG. 4 is a schematic structural diagram of a three-segment electronic blackboard according to an embodiment of the present application;

FIG. 5 is a schematic diagram of a full lamination structure of the liquid crystal display panel in the display area as shown in FIG. 1 or FIG. 3; and

FIG. 6 is a schematic structural diagram of the honeycomb plate 1035 in FIG. 2.

### DETAILED DESCRIPTION

In order to make the purpose, technical solutions and advantages of the present application clearer, the present application is further described in detail by combining with specific embodiments and with reference to the accompanying drawings.

It should be noted that all the expressions of “first” and “second” in the embodiments of the present application are used to distinguish two different entities or parameters with the same name. It can be seen that, the expressions of “first” and “second” are used just for convenience of expression, and should not be understood as a limitation to the embodiments of the present application, which will not be explained one by one in the following embodiments.

Embodiments of the present application will now be described in detail. The embodiments are shown in the accompanying drawings, wherein the same reference numerals always refer to the same components. In the following, exemplary embodiments are described to explain the present application with reference to the accompanying drawings.

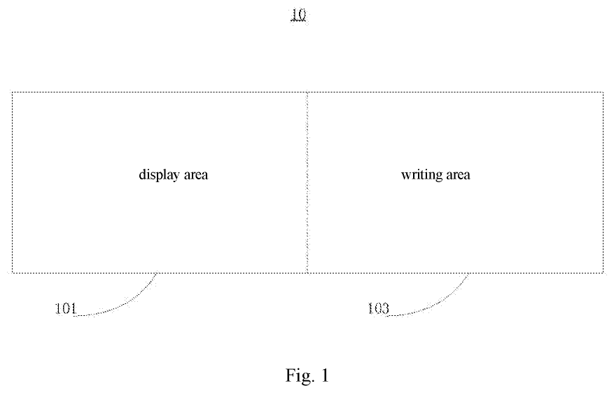

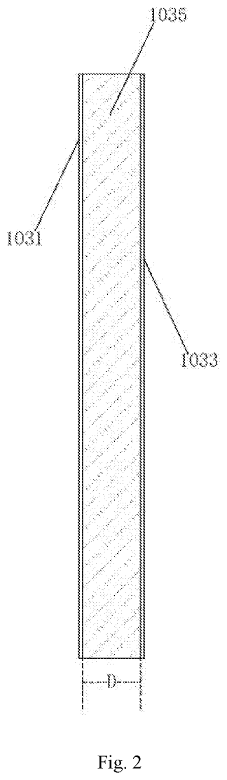

FIG. 1 is a schematic structural diagram of an electronic blackboard according to an embodiment of the present application. As shown in FIG. 1, the electronic blackboard 10 according to the embodiment of the present application may include: a display area 101 and a writing area 103. The display area 101 may include a liquid crystal display panel, the liquid crystal display panel may include a liquid crystal screen, and a glass plate is provided on a surface of the liquid crystal screen; the writing area 103 may include a metal panel. As shown in FIG. 2, the metal panel of the electronic blackboard as shown in FIG. 1 may include a first metal sheet 1031, a support plate 1035, and a second metal sheet 1033 arranged in sequence. Wherein, a surface of the first metal sheet 1031 may be coated with a coating layer for writing with chalk or whiteboard pens. Specifically, the first metal sheet 1031 may be coated with a coating layer for writing with chalk or whiteboard pens on a surface opposite to the support plate 1035, that is, a surface of the first metal sheet 1031 on the side facing away from the support plate 1035 is coated with a coating layer for writing with chalk or whiteboard pens. In some embodiments of the present application, the above coating layer may be black or green, or in other colors. The present application does not limit the color of the above coating layer.

In the above embodiment, the writing area 103 of the electronic blackboard is formed by a metal panel, and the metal panel employs a design of two metal sheets with a support plate provided therebetween, to replace the glass plate in a writing area of the existing electronic blackboard. Thus, the disadvantages of being unclear when writing with chalk or whiteboard pens and tendency towards light reflection may be avoided, and the metal panel has characteristics of high strength, light weight, being not fragile and also low cost.

In the above embodiment, the electronic blackboard 10 is formed in a two-segment structure, that is, the left side is the display area 101, and the right side is the writing area 103.

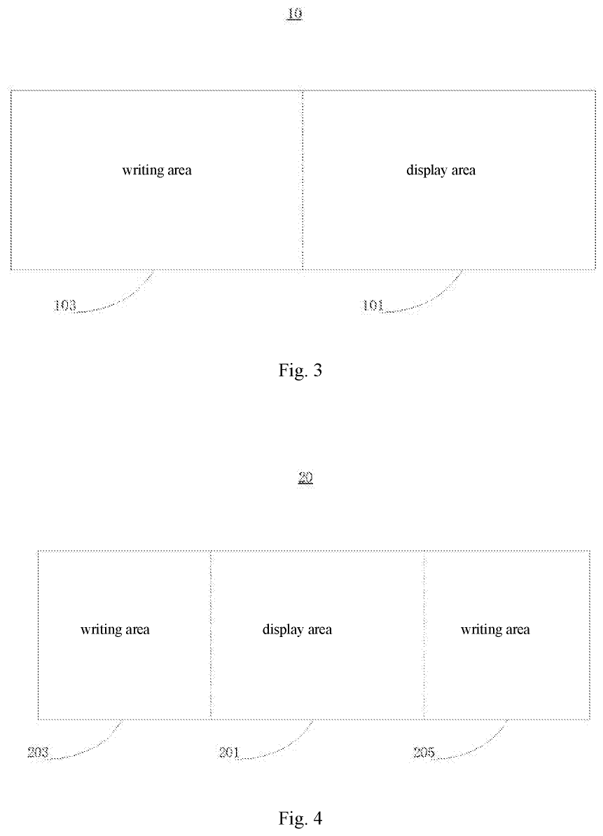

FIG. 3 is a schematic structural diagram of a two-segment electronic blackboard according to another embodiment of the present application. In the embodiment shown in FIG. 3, the electronic blackboard 10 also may be formed as a two-segment structure, but with the right side being the display area 101 and with the left side being the writing area 103.

In some embodiments of the present application, the display area 101 and the writing area 103 may be arranged on a same plane, that is, the liquid crystal display panel and the metal panel are jointed together in a planar manner, so that the electronic blackboard 10 looks like an integrity in appearance and thus is more artistic.

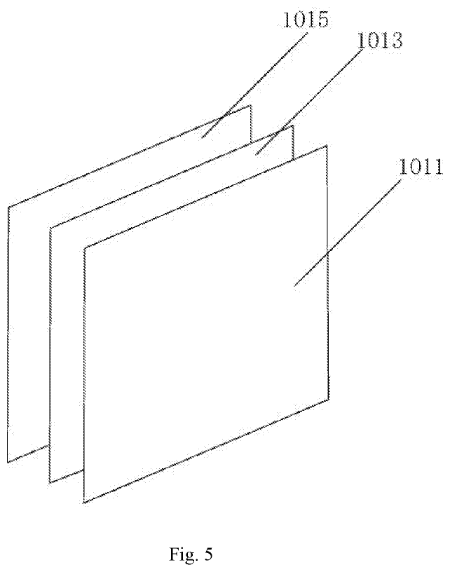

In some other embodiments of the present application, the electronic blackboard may be formed as a three-segment structure. As shown in FIG. 4, the electronic blackboard 20 may include a display area 201 in the middle, and may further include writing areas 203 and 205 located on two sides. Wherein, the display area 201 includes a liquid crystal display panel, the liquid crystal display panel includes a liquid crystal screen, and a glass plate is provided on a surface of the liquid crystal screen; each of the writing areas 203 and 205 includes a metal panel, and a surface of the metal panel is coated with a coating layer for writing with chalk or whiteboard pens.

In some embodiments of the present application, the display area 201 and the writing areas 203 and 205 are arranged on a same plane, that is, the liquid crystal display panel and the metal panel are jointed together in a planar manner, so that the electronic blackboard looks like an integrity in appearance, and thus is more artistic.

Alternatively, as an alternative to the above embodiment, the electronic blackboard 20 may include a writing area in the middle and display areas located on two sides.

It should be noted that, in the embodiments of the present disclosure, the display area 101 and the display area 201 as mentioned above may have a similar configuration, and the writing area 103 and the writing areas 203, 205 may also have a similar configuration. Therefore, the configurations of the display area 201 and the writing areas 203 and 205 will not be repeated here.

In some embodiments of the present application, anti-glare toughened glass may be used for the glass plate of the liquid crystal display panel of the display area 101 or the display area 201. A surface of the above-mentioned anti-glare toughened glass may further be coated with a coating layer for writing with chalk or whiteboard pens. In this way, when the display area 102 or the display area 201 is used for display, the display screen of the liquid crystal screen can be displayed through the anti-glare toughened glass; when the display area 102 or the display area 201 is not used for display, it may be used as a writing area, and form an integral blackboard with the metal panel to provide the writing function.

In some embodiments of the present application, a touch film may be attached to a side of the glass plate of the display area of the electronic blackboard facing the liquid crystal screen, so that the liquid crystal display panel is touch-enabled. In some embodiments, a capacitive touch film or a nano-touch film may be used, and the type of touch film used in the present application is not limited.

FIG. 5 is a schematic diagram of a full lamination structure of liquid crystal display panel of the display area as shown in FIG. 1 or FIG. 3. As shown in FIG. 5, the glass plate 1011 is attached to one side of the touch film 1013 in a full lamination manner, and the other side of the touch film 1013 is attached to the liquid crystal screen 1015 in a full lamination manner. Thus, a full lamination touch screen is formed, which can improve writing effect and thus enhance user experience. Further, the liquid crystal display panel of the display area 201 as shown in FIG. 4 also may be designed similarly in the full lamination manner, which will not be repeated here.

In some embodiments of the present application, the first metal sheet 1031 and the second metal sheet 1033 as mentioned above may be thin steel plates. Specifically, a thickness of the thin steel plate may be no less than 0.2 mm and no more than 1 mm, for example, 0.5 mm or 0.6 mm, which can achieve a lighter weight of the metal panel, while ensuring hardness for the writing.

In some embodiments of the present application, the above-mentioned support plate 1035 may be a honeycomb plate. Since a honeycomb structure has a high strength, a strength of the entire metal panel can be increased.

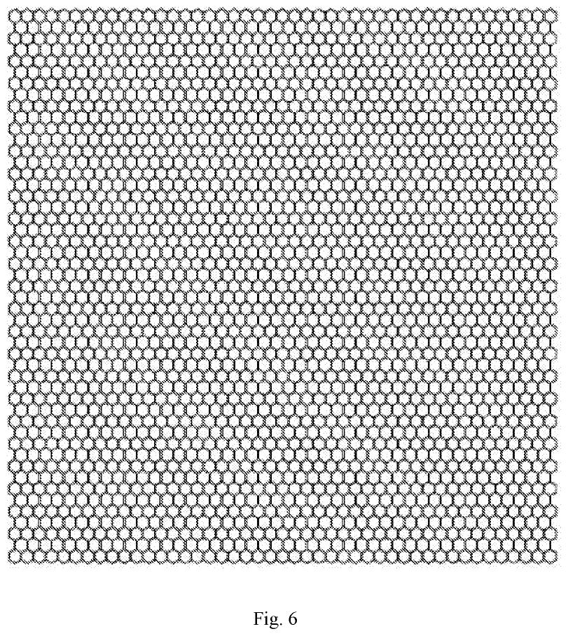

FIG. 6 is a schematic structural diagram of the honeycomb plate 1035 as shown in FIG. 2. Since the first metal sheet 1031 and the second metal sheet 1033 are provided, and the honeycomb plate is provided between the two metal sheets, the first metal sheet 1031 and the second metal sheet 1033 can be supported by the honeycomb plate, which can enhance the structural strength of the entire metal panel, and also can reduce the weight of the entire metal panel.

In some embodiments of the present application, the honeycomb plate may be an aluminum honeycomb plate. The aluminum honeycomb plate is made of light material, and thus can further reduce the weight of the metal panel. In a specific embodiment, a material thickness of the aluminum honeycomb plate may be 0.03 mm to 0.1 mm. Specifically, the material thickness of the aluminum honeycomb plate may be 0.05 mm.

In some embodiments of the present application, a height D of the aluminum honeycomb plate may be set to not less than 10 mm and not more than 20 mm. In a specific embodiment, the height of the aluminum honeycomb plate can be set to 15 mm, which not only ensures the strength of the metal panel, but also does not cause excessive weight of the metal panel.

In some other embodiments of the present application, plates with other structures may be used to replace the honeycomb plate, such as a plate with square structures.

In some embodiments of the present application, the surface of the first metal sheet 1031 is coated with a nano-coating layer, and the nano-coating layer may be black or green, for writing with chalk or whiteboard pens. Specifically, the nano-coating layer may have a Rockwell hardness not less than 3H, to ensure that the writing surface has sufficient hardness.

1. An electronic blackboard, comprising: a liquid crystal display panel and at least one metal panel;
the liquid crystal display panel comprises a liquid crystal screen, wherein a glass plate is provided on a surface of the liquid crystal screen;
the metal panel comprises a first metal sheet, a support plate, and a second metal sheet arranged in sequence, and a surface of the first metal sheet is coated with a coating layer for writing with chalk or whiteboard pens.

2. The electronic blackboard according to claim 1, wherein the liquid crystal display panel and the metal panel are joined together in a planar manner.

3. The electronic blackboard according to claim 1, wherein the glass plate is made of anti-glare toughened glass.

4. The electronic blackboard according to claim 3, wherein a surface of the anti-glare toughened glass is coated with a coating layer for writing with chalk or whiteboard pens.

5. The electronic blackboard according to claim 1, wherein a touch film is attached on a side of the glass plate facing the liquid crystal screen.

6. The electronic blackboard according to claim 5, wherein the glass plate is attached to one side of the touch film in a full lamination manner, and the other side of the touch film is attached to the liquid crystal screen in a full lamination manner.

7. The electronic blackboard according to claim 1, wherein the first metal sheet and the second metal sheet are thin steel plates.

8. The electronic blackboard according to claim 7, wherein a thickness of the thin steel plate is no less than 0.2 mm and no more than 1 mm.

9. The electronic blackboard according to claim 1, wherein the support plate is a honeycomb plate.

10. The electronic blackboard according to claim 9, wherein the honeycomb plate is an aluminum honeycomb plate.

11. The electronic blackboard according to claim 10, wherein a height of the aluminum honeycomb plate is no less than 10 mm and no more than 20 mm.

12. The electronic blackboard according to claim 11, wherein the height of the aluminum honeycomb plate is 15 mm.

13. The electronic blackboard according to claim 10, wherein a material thickness of the aluminum honeycomb plate is 0.03 mm to 0.1 mm.

14. The electronic blackboard according to claim 13, wherein the material thickness of the aluminum honeycomb plate is 0.05 mm.

15. The electronic blackboard according to claim 1, wherein the coating layer on the surface of the first metal sheet is a nano-coating layer.

16. The electronic blackboard according to claim 15, wherein the nano-coating layer has a Rockwell hardness not less than 3H.
